(19) United States
(12) Patent Application Publication
(10) Pub. No.: US 2004/0162850 A1
(43) Pub. Date: Aug. 19, 2004

(54) Managing operations of a product dispense system

(76) Inventors: Katherine M. Sanville, White Bear Lake, MN (US); Richard Mehus, Richfield, MN (US)

Correspondence Address: MERCHANT & GOULD PC, P.O. BOX 2903, MINNEAPOLIS, MN, 55402-0903, US

(21) Appl. No.: 10/369,821

(22) Filed: Feb. 19, 2003

(51) Int. Cl. G06F 17/00

(52) U.S. Cl. 707/103 Y

(57) ABSTRACT

A method and system for managing chemical usage by service representatives that request dispensing of a chemical product by a chemical dispense system is disclosed. The chemical dispense system prepares and/or dispenses chemical products for service representatives in response to requests by the service representatives. Each service representative that is authorized to use the chemical dispense system is assigned a user identifier (ID). In response receiving a user ID, the chemical dispense system presents on a graphical user interface one or more predetermined chemical products that the service representative is authorized to use. These products are determined based on the user ID. The chemical dispense system prepares and/or dispenses a chemical product in response to the service representative selection of that chemical product. The user ID, the name of the chemical product, and the volume of the chemical product are linked together and associated with a time reference. This information is sent to a central server for analysis related to the chemical usage trends of the service representative.

### TECHNICAL FIELD

The invention relates generally to management over product dispense systems, and more particularly, to monitoring dispensing operations of a chemical dispense systems.

### BACKGROUND OF THE INVENTION

Service representatives are individuals hired to clean and/or sanitize various objects and areas of buildings, facilities, complexes and campuses. For example, large casino-hotels, shopping malls and college and business campuses typically utilize numerous service representatives to clean and sanitize bathrooms, kitchens, entrance ways and common areas, e.g., gambling halls, classrooms, etc. The service representatives are managed by one or more enterprises each responsible for one or more tasks to be performed at the buildings, facilities, objects and areas. An enterprise includes at least one management entity that manages the service representatives employed by the enterprise. The management entity of an enterprise may also be the enterprise's liaison between the enterprise and a management entity for serviced building, facility, object or area.

An enterprise may be, for example, without limitation, a company hired to sanitize bathrooms of a large casino facility, a company hired to wash linens at a hotel of the casino facility, a company hired to wash wares and utensils at a restaurant at the casino facility and a company hired to clean floors of the casino facility. Service representatives employed by this type of enterprise are referred to as “external” service representatives. More generally, external service representatives are defined as employees of an entity other than the management of the buildings, facilities, complexes and campuses that the representatives are responsible for cleaning. As such, external service representatives are often referred to as service contractors. An enterprise may also be the owner or managing entity of the large casino facility, in which case, the owner has taken responsibility of a particular set of related cleaning tasks rather than contracting an outside enterprise. Service representatives employed by this type of enterprise are referred to as “internal” service representatives. More generally, internal service representatives are those individuals that are employed the management of buildings, facilities, complexes or campuses that they are responsible for cleaning.

Service representatives typically use chemical products in performance of their assigned tasks, e.g., cleaning and sanitizing objects and areas of a building, facility, complex or campus. One way to stock the necessary chemical product supply is to order the chemical products from a retailer/distributor. However, ordering the chemical products in this “pre-formed” state is often costly, and many times, delivery of needed chemical products is delayed due to backlogs at the retailer/distributor. An on-site chemical dispense system alleviates the overhead of having to order pre-formed chemical products by providing for formulation and allocation of chemical products at the buildings, facilities and areas where the chemical products are to be used. Formulation is generally defined as preparation of a chemical product according to a specialized formula. Allocation is generally defined as distribution of a formed chemical product according to a specified plan. The on-site chemical dispense systems enable service representatives to request and consequently receive chemical products that they need to perform their duties and responsibilities.

Although on-site chemical dispense systems are more cost and time efficient than the alternative approach of ordering and waiting for pre-formed chemical products, these systems are not without problems. Current systems allow unlimited operation by service representatives. In many circumstances, a service representative may be using too much of a particular chemical product than required for his/her specific responsibilities. Furthermore, a service representative may be requesting and using chemical products that are not required for his/her responsibilities. Conventional on-site chemical dispense systems lack the ability to accommodate for an enterprise to monitor chemical usage by its service representatives as well as the ability for facility and building owners to monitor chemical usage by a particular enterprise. For this reason, it is becoming somewhat economically inefficient for facilities and buildings to continue providing chemical formulation services to enterprises that the facilities and buildings have hired to perform certain cleaning tasks.

### SUMMARY OF THE INVENTION

In accordance with the present invention, the above and other problems are solved by a method and system for managing operations of a product dispense system, wherein the product dispense system dispenses one or more chemical products in response to requests by service representatives. In one embodiment, a chemical dispense system prepares a chemical product by dispensing multiple chemical concentrates to a common location, which is generally referred to as a dispense location. The chemical product is formed as the combination of the multiple concentrates at the dispense location. As such, the chemical product is referred to as having been dispensed to that location. In a second embodiment, a chemical dispense system is not responsible for preparing the chemical product, but rather dispenses pre-formed chemical products to the dispense location. The chemical dispense system includes a display monitor through which a graphical user interface is presented. The graphical user interface enables authorized users to select chemical products that they would like the chemical dispense system to dispense.

In accordance with an embodiment, the present invention monitors chemical usage by enterprises responsible for performance of cleaning tasks at a facility, building, complex or campus. Each of the cleaning tasks require application of a chemical product prepared and/or dispensed by a chemical dispense system. Each enterprise is associated with an enterprise identifier (ID), and thus each service representative employed by a particular enterprise is associated with the same enterprise ID. Each service representative is also associated with a unique user identifier (ID). In order to request a specific chemical product, a service representative must input into the chemical dispense system either his/her enterprise ID or his/her user ID, which is in turn used to determine the service representative's enterprise ID. The enterprise ID is linked to the volume and name of the chemical product dispensed to the service representative along with a time reference relative to a time when the chemical product was dispensed. This linked information is then stored in a database for subsequent use in analyzing chemical usage trends of a particular enterprise over a given period of time.

In accordance with another embodiment, the present invention monitors chemical usage by service representatives that request chemical products from one or more chemical dispense systems. Each service representative that is an authorized user of a chemical dispense system is assigned a unique user ID. In this embodiment, the chemical dispense system includes an identification module and a host computer. The host computer communicates with a central server, i.e., remote computer, over an established network connection. The host computer includes, or is coupled to, a communication device for establishing this network connection. The network connection may be a continuous or periodic connection.

In order to request a chemical product, a service representative first enters his/her user ID into the identification module, e.g., a graphical user interface, fingertip identification reader or card reader, of the chemical dispense system. The host computer receives the entered user ID by way of the identification module. In accordance with an embodiment, the host computer transmits the user ID to the central server by way of the communication device. The central server then compares the user ID to each of the user ID's assigned to service representatives, and if a match is found, the service representative is determined to be an authorized user. Once authorized, the service representative is allowed to instruct the chemical dispense system to dispense a desired chemical product through the graphical user interface. In another embodiment, these authorization operations are performed by the host computer rather than the central server.

Chemical dispense systems dispense chemical products in response to selections of the chemical products by authorized users. The authorized user may be an internal or external service representative. In an embodiment, the user ID's of the authorized service representatives accessing the chemical dispense systems, the names of the chemical products dispensed and the volume of these chemical products are collected and transmitted by the host computers of each chemical dispense system to the central server. Either prior to being transferred to the central server, or alternatively, once received by the central server, the above-noted information associated with each instance that a chemical product is dispensed to a service representative is linked together and associated with a time reference relative to a point in time corresponding to each instance, i.e., when the chemical product is dispensed to the service representative. The central server analyzes this information as well as the corresponding time references to render an evaluation related to chemical product usage by one or more of the service representatives over a given period of time. In other embodiments, the host computer or a client computer connected to the central server by a communication link may analyze this information to render this type of evaluation.

In an embodiment, the user ID's of the authorized service representatives accessing the chemical dispense systems, the names of the chemical products dispensed, the volume of these chemical products and the corresponding time references are recorded in a data structure specific to each chemical dispense system connected to the central server. The data structures are stored in a database accessible to the central server, and therefore, accessible to the host computer over the network connection. The information recorded in a data structure is analyzed by the central server, the host computer or the client computer to render the evaluation related to chemical product usage by one or more of the service representatives as well as their associated enterprise(s) during a given period of time. The information recorded in a data structure may also be analyzed to render evaluations related to operational and efficiency characteristics of the chemical dispense system associated with that data structure.

In accordance with another embodiment of the present invention, the types and volume of chemical products available to a service representative are limited based on an assignment of one or more predetermined chemical products, and volume of these chemical products, to the user ID for that service representative. Upon receiving an entered user ID, the central server determines which chemical products the service representative assigned to that user ID is authorized to use. The central server then sends this information to the host computer, which populates the graphical user interface with the one or more predetermined chemical products assigned to the user ID. In another embodiment, the host computer, which receives the user ID-chemical product assignments during periodic or continuous communication sessions with the central server, may perform the above-noted determination.

The invention may be implemented as a computer process, a computing system or as an article of manufacture, such as, a computer program product. The computer program product may be a solid state, non-volatile memory device or a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 is a diagram of a chemical dispense system in accordance with an embodiment of the present invention and the associated environment.

FIG. 2 illustrates an exemplary network of chemical dispense systems communicatively connected to a server computer in accordance with an embodiment of the present invention.

FIG. 3 depicts a block diagram of a suitable computing environment in which an embodiment of the present invention may be implemented.

FIG. 4 is a flow diagram that illustrates operational characteristics for monitoring usage of chemical products by enterprises employed to manage cleaning tasks for an owner/manager of a facility, building, complex or campus in accordance with an embodiment of the present invention.

FIG. 5 is a flow diagram that illustrates operational characteristics for managing usage of one or more chemical products by service representatives in accordance with an embodiment of the present invention.

FIG. 6 is a flow diagram that illustrates operational characteristics for monitoring usage of one or more chemical products by service representatives in accordance with an embodiment of the present invention.

### DETAILED DESCRIPTION

The present invention and its various embodiments are described in detail below with reference to the figures. When referring to the figures, like structures and elements shown throughout are indicated with like reference numerals.

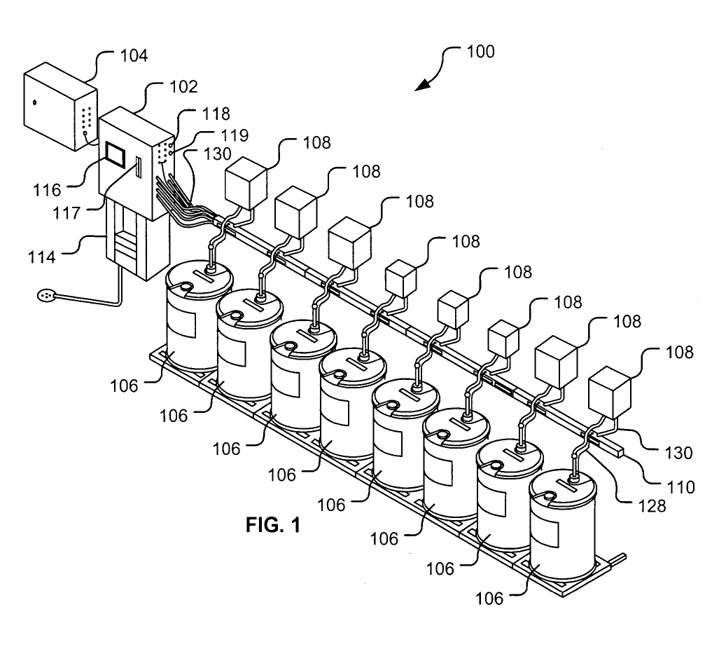

The present invention provides a method and system for managing chemical usage by service representatives of enterprises employed to manage cleaning tasks for an owner/manager of a facility, building, complex or campus in accordance with an embodiment of the present invention. In accordance with an embodiment of the present invention, service representatives are broadly defined herein as personnel responsible for cleaning an area of a building, facility, complex or campus using one or more chemical products prepared and/or dispensed by a chemical dispense system, such as the exemplary chemical dispense system 100 shown in FIG. 1. For example, without limitation, a service representative may be a contractor, part-time employee, full-time employee, agent, officer, board member or volunteer. In accordance with this embodiment, a service representative is any individual directly responsible for applying a chemical product to a point-of-use, such as an area, article or device.

Referring to FIG. 1, an embodiment of the present invention is shown wherein operations of a product dispense system 100 are managed to monitor and/or control product usage by service representatives employed by a plurality of enterprises to perform a task using products dispensed by the system 100. In accordance with an exemplary embodiment, the product dispense system 100 shown in FIG. 1 is a chemical dispense system that dispenses one or more chemical products in response to requests by service representatives. The chemical dispense system 100 shown in FIG. 1 is a type of chemical dispense system that not only dispenses the one or more chemical products, but also prepares the one or more chemical products by dispensing multiple chemical concentrates to a common location, which is generally referred to as a dispense location. The chemical product is formed as the combination of the multiple concentrates at the dispense location. As such, the chemical product is referred to as having been “dispensed” to that location. In an alternative embodiment, the chemical dispense system managed using the present invention may be of the type that dispenses pre-formed chemical products to the dispense location. In this embodiment, the chemical dispense system is not responsible for preparing the chemical products dispensed to the dispense location.

The chemical dispense system 100 includes a formulator 102 that dispenses chemical concentrates to the dispense location. The dispense location is shown in FIG. 1 as a fill station 114, wherein the concentrates are provided to a storage container, such as, without limitation, a jug, situated within the fill station 114. The chemical concentrates combine with one another at the dispense location, e.g., in a jug, to form a chemical product. In another embodiment, the dispense location may be a point-of-use rather than a fill station 114. A point-of-use is a location where the chemical product may be used to accomplish a desired task, such as, without limitation, cleaning, filling, rinsing or otherwise utilizing. The chemical concentrates are provided to the point-of-use using a dispense hose (not shown) extending from the formulator 102 to the point-of-use. For example, a chemical product may be sprayed on a surface at a point-of-use.

Although the storage container is hereinafter referred to as a jug, the storage container may be any container or reservoir operable to hold a chemical product. Other containers may be drums (not shown) and tote or bulk tanks (not shown). If dispensed to a drum, the chemical concentrates are provided to the drum using a dispense hose (not shown) extending from the formulator 102 to the drum.

The formulator 102 formulates, i.e., prepares according to a specialized formula, chemical products using a plurality of chemical concentrates. The appropriate chemical concentrates are dispensed to the dispense location to form a specific chemical product. If dispensed into a jug at the fill station 114, the chemical product is thereafter stored for transfer to a point-of-use where the chemical product is used by a service representative to perform a desired task. If dispensed into a drum, the chemical product is thereafter stored for allocation, i.e., distribution according to a specified plan, by an allocator 104.

In accordance with an embodiment, the allocator 104 may be programmed to distribute the stored chemical product to a particular point-of-use at a predetermined time or during a predetermined distribution sequence wherein a plurality of chemical products are distributed to the point-of-use. In accordance with yet another embodiment, the allocator 104 may also be programmed to distribute the chemical product to a jug at a predetermined time or during a particular sequence wherein a plurality of chemical products are distributed to a jug. In accordance with yet a further embodiment, the allocator 104 may also be used to manage the distribution of chemical concentrates to a dispense location for formulation of a chemical product such that the chemical product is formulated based on a plan or sequence loaded into the allocator 104. Although not shown in FIG. 1, the allocator 104 may include a display, such as display 116, presenting a graphical user interface for local input and control by users.

Prior to being supplied to the formulator 102, the chemical concentrates are stored in concentrate containers 106. Because the chemical concentrates are ultimately used to form various chemical products, the term “component” may be used to refer to one or more specific chemical concentrate(s) used by the formulator 102 to form a chemical product. The formulator 102 controls operation of a plurality of concentrate pumps 108. Each concentrate pump 108 extracts the chemical concentrate stored in an associated concentrate container 106 and supplies pressure to push or pass the chemical concentrate through concentrate conduits 130 to a manifold located inside the formulator 102. More specifically, based on user instructions, the formulator 102 selects one or more concentrate pumps 108, one at a time in a preprogrammed sequence, for activation in accordance with an embodiment of the present invention. Alternatively, the formulator 102 may activate multiple concentrate pumps 108 in a substantially simultaneous manner such that multiple concentrates may be provided to the manifold during a given time period.

Each concentrate pump 108 is associated with a specific chemical concentrate stored in a specific concentrate container 106. Each concentrate pump 108 is attached to an associated concentrate container 106 via a container-pump connection 128. The container-pump connection shown in FIG. 1 as a pipe 128 may be any form of pipe, conduit or hose.

Upon activation to supply a stored chemical concentrate to the manifold, the concentrate pump 108 transfers the chemical concentrate from the concentrate container 106 to the pump 108 through the pipe 128. The pump 108 funnels each chemical concentrate from the pipe 128 to the manifold via a pump-manifold connection 130, which may be any form of pipe, conduit or hose. In accordance with an embodiment, the manifold connects to eight pump-manifold connections 130, and thus, eight different chemical concentrates may be supplied to the manifold in turn. Alternatively, the manifold may connect to any number of pump-manifold connections 130, and thus, receive any number of concentrates in turn. For clarity, the pump-manifold connection 130 is hereinafter referred to as a “concentrate conduit.”

Chemical concentrates are discharged from the formulator 102 to the dispense location through the manifold. A dispense hose for directing the chemical concentrates from the formulator 102 to the dispense location may be operably connected to an output of the manifold. In accordance with an embodiment, a flow meter (not shown) is coupled between the output of the manifold and the dispense hose. The flow meter measures the volume of flow of each chemical concentrate used to form a particular chemical product through the dispense hose. With this information, the chemical dispense system 100 monitors various dispensing aspects associated with the formulator 102, such as, but not limited to, proof of delivery of a particular chemical product. In addition, the flow meter provides a mechanism for detecting fault with the various mechanical parts of the chemical dispense system 100 if the expected chemical product is not being properly formulated. The flow meter is described in greater detail in U.S. patent application Ser. No. 10/188,714, entitled Flow-Based Chemical Dispense System, assigned to the assignee of the present application and incorporated into this application by reference.

In accordance with one possible embodiment, the fill station 114 is sized to include a jug for receiving the chemical concentrates as the concentrates are dispensed from the formulator 102 to the fill station 114. As such, the dispense hose of the formulator protrudes into the jug. The jug may be any size, but in accordance with various embodiments, is a 1.5-gallon (6 liter) jug, a 2.5-gallon (10 liter) jug or a 5-gallon (20 liter) jug. A second dispense hose (not shown) may be affixed to a second output of the formulator 102 in accordance with an embodiment of the present invention. The second dispense hose may be used to fill drums with specific chemical products formulated by the formulator 102. Alternatively, the formulator 102 may have only a single dispense hose, as described above, wherein the dispense hose may be positioned to fill either a jug situated in the fill station 114 or a drum with a specific chemical product.

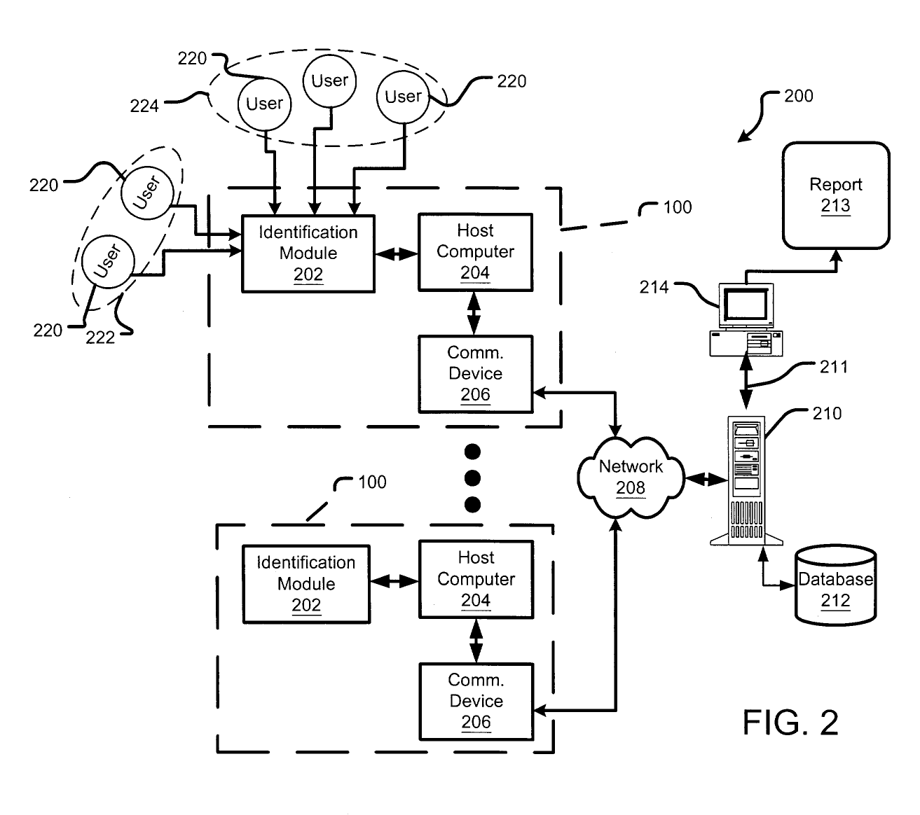

The formulator 102 includes a host computer (not shown in FIG. 1, 204 in FIG. 2) for locally monitoring and controlling operation of the chemical dispense system 100. Information collected by the flow meter is provided to the host computer for processing and, in accordance with one embodiment, storage. In an embodiment, the host computer includes a storage device (not shown) on which a graphical user interface application program is stored. The storage device may also store information, i.e., user ID's, chemical product selections, instructions, etc., input by an authorized user as well as information collected by the flow meter. The term “storage device” is broadly used herein to encompass of any form of computer program product readable by a computer system and encoding a computer program of instructions for executing a computer process. Several exemplary storage devices include, without limitation, solid state, non-volatile memory device, computer storage media and signals propagated on a carrier.

The host computer executes the graphical user interface application program to present a graphical user interface (GUI) on a display monitor 116 located on the outer frame of the formulator 102. In accordance with an embodiment, the GUI is a touch-screen interface operating on a Microsoft Windows CE™-based operating system. Other than the touch-screen GUI, the GUI may be any other conventional GUI through which a user may input instructions for monitoring and/or controlling operations of the chemical dispense system 100.

Authorized users are granted access to operate and control the chemical dispense system 100 through the touch-screen GUI presented on the display monitor 116 in accordance with an embodiment of the present invention. An authorized user is an individual, typically either an internal service representative or an external service representative, who has been setup with a user ID for operating the chemical dispense system 100. Each authorized user may also be assigned a password for his/her user ID. To operate the chemical dispense system 100, a potential user enters his/her user ID, and possibly an associated password, through the touch-screen GUI. The host computer performs identification and authentication procedures based on the user ID input to the touch-screen GUI. If the potential user is identified and authenticated as an authorized user to the chemical dispense system 100, access to the system 100 is granted thereby enabling the user to operate and/or control the system 100 through the touch-screen GUT.

In accordance with an embodiment, authorized users are service representatives authorized to request one or more chemical products from the chemical dispense system 100. The user ID's are unique to the service representatives in that no two service representatives are assigned the same user ID. For example, without limitation, a user ID may be a personal identifier such as an employee identification number or a social security number.

In accordance with one possible embodiment, the formulator 102 also includes a card reader 117 that provides another way of access such that an authorized user, e.g., a service representative, can operate and/or control the chemical dispense system 100 in order to request a particular chemical product. As such, a potential user desiring access to the chemical dispense system 100 may swipe an access card through the card reader 117 to gain such access. The host computer performs identification and authentication procedures based on information, i.e., the user ID stored on the access card. If the potential user is identified and authenticated as an authorized user of the chemical dispense system 100, access to the system 100 is granted thereby enabling the user to operate and control the system 100 through the touch-screen GUI.

Once an authorized user is granted access, the user can request a specific chemical product through the touch-screen GUI. The formulator 102 prepares a requested chemical product by combining water and/or one or more component chemical concentrates in a jug situated in the fill station 114. Preparation may include either allocation or formulation of a chemical product; however, for illustrative purposes, preparation is hereinafter described as formulation in accordance with an exemplary embodiment. Water may be input to the formulator 102 through a water inlet 118. The term “chemical concentrate” refers to both water and all other chemical concentrates used by the formulator 102 in preparing a chemical product.

In accordance with one possible embodiment, each service representative is authorized to use the chemical dispense system 100 to request one or more specified chemical products. These chemical products may be specified by the management of the building or facility where the chemical dispense system 100 is located, or instead, by the management entity of the enterprise employing the service representative. In one embodiment, the building manager, facility supervisor or the enterprise's management entity locally enters chemical product assignments for each service representative to the host computer using the touch-screen interface. These assignments may be entered periodically, i.e., daily, weekly, monthly, yearly, or random. In accordance with another embodiment, the building manager, facility supervisor or the enterprise's management entity enters chemical product assignments for each service representative to the host computer from a remote computer, wherein both the host computer and the remote computer access and pass data between a central server, as shown in FIG. 2. Again, these assignments may be entered periodically, i.e., daily, weekly, monthly, yearly, or random.

As noted in the preceding paragraphs, the host computer uses the service representative's user ID to select specific chemical products the chemical dispense system 100 is authorized to dispense to that service representative. Thus, after a service representative enters his/her user ID, one of two scenarios exist. In a first embodiment, if the service representative is only authorized one chemical product, that chemical product is the only product displayed for selection on the touch-screen GUI. In response to selection of this chemical product by the service representative, the host computer directs the formulator 102 to initiate formulation. Alternatively, the host computer may automatically direct the formulator 102 to formulate this chemical product without prompting the service representative with the single selection choice. In accordance with a second embodiment, if the service representative is authorized to use multiple chemical products, each of these chemical products are displayed for selection on the touch-screen GUI. The service representative may then select which chemical product he/she would like the chemical dispense system 100 to dispense first. In response to selection of this chemical product by the service representative, the host computer directs the formulator 102 to initiate formulation. Alternatively, the order in which the service representative is to receive these chemical products may be preprogrammed into the host computer such that the service representative is provided the chemical products in a predetermined sequence.

In accordance with an embodiment of the present invention, the host computer monitors chemical usage of each authorized service representative by linking the volume and name of each chemical product dispensed by the chemical dispense system 100 with the user ID of the service representative that requested the chemical product. In accordance with one possible embodiment, the host computer also time stamps the user ID, the volume and the name of the chemical product dispensed by the chemical dispense system 100 with calendar date and clock information such that this information is associated with a particular time reference relative to each instance that a chemical product is dispensed by the chemical dispense system 100 in response to a request by a service representative. The user ID, the volume and name of chemical product dispensed by the chemical dispense system 100 as well as the associated time reference, which includes both the calendar date and clock information, are saved to a data structure, e.g., a data file, stored in the host computer. The data structure is a compilation of user ID's of each service representative that has requested formulation of a chemical product, the volumes and names of chemical products formulated by the formulator 102 and corresponding time references relative to a point in time when each chemical product is dispensed to a service representative. Table 1, below, is an illustration of an exemplary data structure in which the above-noted information is saved in tabular form.

TABLE 1

| | | | | Volume |
|---|---|---|---|---|
| Date | Time | User ID | Chemical Product | (liters) |
| Jan. 18, 2002 | 07:30:45 | 456-83-9968 | Multipurpose/Floor | 20 |
| | | | Cleaner | |
| Jan. 18, 2002 | 07:31:20 | 439-96-9578 | Floor Polish | 15 |
| Jan. 18, 2002 | 07:31:40 | 478-09-3820 | Bowl & Bathroom | 10 |
| | | | Cleaner | |
| Jan. 18, 2002 | 07:32:10 | 439-96-9578 | Multipurpose/Floor | 25 |
| | | | Cleaner | |
| Jan. 18, 2002 | 07:32:30 | 478-09-3820 | Insect Repellant | 6 |

In accordance with an embodiment, data stored on a local storage device of the host computer is uploaded to a remote computer such that operation of the chemical dispense system 100 can be monitored and managed from a remote location. To accomplish such remote control, the host computer includes a data communications port 119. The data communications port 119 connects the chemical dispense system 100 to a client-server network. The data communications port 119 may be a phone jack, Ethernet port, wireless transmission means, a dedicated communication line or any other conventional networking port or device operable to allow a remote computer to communicate with the host computer. Information collected by the host computer and stored in the data structure is sent to the remote computer via the data communications port 119, thereby enabling remote monitoring and management over chemical usage by service representatives. In accordance with an alternative embodiment, the data structure may be created and updated by the remote computer. In this embodiment, information collected by the chemical dispense system 100, e.g., user ID's, volume and names of dispensed chemical products, is sent directly to the remote computer over a substantially continuous network connection between the host computer of the chemical dispense system 100 and the remote computer. Furthermore, either the host computer or the remote computer may stamp the collected information with a time reference.

FIG. 2 illustrates an exemplary network 200 of chemical dispense systems 100 communicatively connected to a server computer 210 in accordance with an embodiment of the present invention. The server computer 210 is accessible to each chemical dispense system 100 in the network 200 by way of a communication network 208. It should be appreciated that the communications network 208 may be any type of network known to those skilled in the art or an equivalence thereto. Some exemplary networks include, without limitation, the Internet, an Intranet, a private line network, or even a direct communication link. It should also be understood that the communications network 208 may utilize any number of communication technologies depending on functions required by the embodiment. Examples of specific technologies used in communications networks 104 contemplated include without limitation terrestrial, cellular, satellite, short-wave, and microwave connections to the Internet, directly between facilities using modems or other interface devices, or through other communications networks, such as local area networks or wide area networks. Any combination of these or other communications networks may be utilized and remain within the scope of the invention.

The chemical dispense systems 100 included within the network 200 may be located at multiple facilities, buildings or locations associated with multiple business entities in accordance with one possible embodiment of the present invention. In accordance with another embodiment, however, the chemical dispense systems 100 connected to the central server 210 are located at multiple facilities, buildings or locations associated with a single business entity. In accordance with yet another embodiment, the chemical dispense systems 100 are located at a single facility, building or location associated with a single business entity.

Service representatives, shown in FIG. 2 as users 220, access the chemical dispense systems 100 to request chemical products for use in cleaning objects and areas of a building, facility, complex or campus. Each service representative 220 is employed by an enterprise, which are illustrated in dashed lines in FIG. 2 as a first enterprise 222 and a second enterprise 224. The term “employed by” is defined broadly herein to encompass any form of association between a service representative 220 and an enterprise, e.g., 222 and 224, wherein the service representative 220 performs some task for or on behalf of the enterprise, e.g., 222 and 224.

The enterprises, e.g., 222 and 224, are hired by the owner or manager of the building, facility, complex or campus to take over responsibility of various cleaning tasks. The enterprises, e.g., 222 and 224, are each associated with a unique enterprise identifier (ID). As such, each service representative 220 is associated with the enterprise ID of the enterprise, e.g., 222 and 224, employing the service representative 220. As illustrated above, each service representative is also associated with a unique user ID. Although only two enterprises, e.g., 222 and 224, are illustrated in FIG. 2, any number of enterprises, e.g., 222 and 224, may be hired by a facility, building, complex or campus owner/manager to manage performance of cleaning tasks.

In the embodiment shown in FIG. 2, a host computer 204 of the chemical dispense system 100 is connected to, or alternatively, includes, a communication device 206 for communicating with the server computer 210. The communication device 206 uploads collected information, e.g., enterprise ID's, user ID's, names of dispensed chemical products and corresponding time references, to the server computer 210, or “central server,” by way of the communication network 208. The communication device 206 may be any type of device used to transmit data from a local computer, such as the host computer 204, to the central server 210 over the communication network 208. For instance, the communication device 206 may be a modem, a network interface card (NIC) alone or in combination with a router, hub or Ethernet port, a wireless transmitter, etc. The communications device 206 accesses the communication network 208 by a LAN (local area network), WAN (wide area network), a dial-up connection, or any other well-known network connection. Data are provided to and exit the communication device 206 via the data communications port 119 shown in FIG. 1.

The host computer 204 connects to the central server 210 using the communication device 206, and once connected, transmits data over the connection to the central server 210. The data is forwarded from the central server 210 to a database 212 which updates an appropriate data structure to include the recently collected information. The database 212 stores any number of data structures, with each data structure being associated with (1) the specific chemical dispense system 100 from which the collected data originates; (2) an enterprise authorized to access the system 100; or (3) a service representative authorized to access the system 100. Once updated, the information recorded in the data structure stored in the database 212 may be processed by the central server 210 or other remote computers, e.g. client computer 214, to render conclusions relating to chemical usage trends of service representatives 220 that access the chemical dispense system 100 associated with the data structure. This information may also be used to render conclusions relating to chemical usage trends of an enterprise as a whole.

Generally, the central server 210 monitors operations of various chemical dispense systems 100, each having an identification module 202, host computer 204 and a communication device 206, as shown in FIG. 2. For illustrative purposes, the network 200 is shown in FIG. 2 as having two chemical dispense systems 100 connected to the central server 210 over the communication network 208. However, it should be appreciated that the network 200 may include any number of chemical dispense systems 100. Indeed, the central server 210 may be configured to receive data from any number of chemical dispense systems 100.

The host computer 204 includes a processor (central processing unit—CPU), a host application program and a storage device. The host computer 204 includes or is operably connected to an identification module 202 for accepting user ID's from service representatives 220 desiring access to the chemical dispense system 100. The identification module 202 is shown in FIG. 1 as being either a touch-screen GUI presented through the display monitor 116 or a card reader 117. In accordance with another embodiment, the identification module 202 may be a fingertip identification reader.

When attempting to access a chemical dispense system 100, a service representative may input both his/her user ID and enterprise ID. However, in accordance with an embodiment illustrated below, the service representative only enters his/her user ID, which is subsequently used by either the host computer 204 or the central server 210 to determine the service representative's enterprise ID. The identification module 202 transmits each user ID to the host computer 204. After the host computer 204 receives a user ID transmitted from the identification module 202, the processor executes the host application program to associate the user ID with one or more chemical products that the service representative 220 is authorized to use. Chemical products associated with the user ID are downloaded to the host computer 204 from the central server 210 over either a continuous or periodic network connection. The names of the authorized chemical products are displayed on the touch-screen GUI for selection by the service representative 220.

As an authorized chemical product is selected by the service representative 220, the host application program records the name of the selected chemical product, the requested volume of the selected chemical product, and the user ID of the service representative 220 making the selection. The host application program also time-stamps this information relative to a point in time that each chemical product is selected. Time stamping is the association of each user ID with a time reference, including, without limitation, calendar date and clock information. In accordance with an embodiment, the host application program may also determine the enterprise ID associated with the service representative based on the entered user ID. The volume and name of each chemical product selected by a service representative 220, the enterprise and user ID of the service representative 220 selecting the chemical product, and the time reference for the selection are stored on the storage device as a data structure, i.e., data file. In an embodiment, the storage device temporarily stores the above-noted information. In another embodiment, the storage device may be omitted altogether, particularly if generally continuous communication of the names and volume of selected chemical products, user ID's and corresponding time references are made to the remote database 212.

In an embodiment of the present invention, the communications device 206 periodically accesses the central server 210 to provide data for storage in the database 212. In this embodiment, the data structure stored on the local storage device of the host computer 204 is periodically uploaded to the central server 210 by the communication device 206. As such, the communication device 206 may access real-time data received by the host computer 204 and any historical data stored on the local storage device for transfer to the database 212. In the alternative embodiment noted in the preceding paragraph, the communications device 206 maintains communications with the central server 210 over the communications network 208 continually; therefore, the local storage device is unnecessary for storing detected data. Instead, the communications device 206 continually transmits real-time data collected by the host computer 204 to the central server 210. In this embodiment, a small cache device may nevertheless be employed to accommodate network congestion or other communication delays at the communications device 206.

The communications device 206 also receives commands via the communications network 208 to provide a feedback loop to the chemical dispense system 100 in accordance with an embodiment of the present invention. These commands are transferred to the host computer 204 for use in controlling processes and operations of the chemical dispense system 100. These commands may include formula updates for chemical concentrates as well as instructions to prepare a specific chemical product for a service representative 220 based on a user ID that has been collected by the identification module 202. This feedback loop also provides for interactive communications between the service representative 220 and the central server facility, and other remote control commands. This capability facilitates the management of multiple, geographically dispersed chemical dispense systems 100 by allowing building management to monitor operations and distribute control commands from a central location via the communication network 208.

A client computer 214, e.g., a thick or thin client, is connected to the central server 210 by way of a communication link 211. The communication link 211 is shown as a direct link, but may alternatively be the Internet, an Intranet, a private line network, or any other type of network known to those skilled in the art. The client computer 214 initiates an analysis application resident on the client computer 214 or resident on the central server 210 to generate reports, such as report 213 providing analysis of data recorded in the database 212. As noted above, the database 212 includes the user and enterprise ID's of each service representative 220 that has requested formulation of a chemical product, the volumes and the names of chemical products dispensed for each user ID and the time references relative to a point in time when each requested chemical product was dispensed by a chemical dispense system 100. As such, report 213 may include, for example, results from an analysis related to the amount of chemical usage, e.g., volume of chemical products dispensed by the chemical dispense system 100, to a specific service representative 220.

In accordance with one possible embodiment, the report 213 may include a listing of all service representatives 220 that received a jug of chemical product over a given period of time along with the type of chemical products contained in the jugs. The analysis application may also determine whether a particular service representative 220 is using too much or not enough chemical product for the tasks assigned to that contractor over a given period of time. The analysis application program may also determine the volume and type of chemical products dispensed for a particular enterprise over a given period of time. Such features may be determined by the analysis application based on the user ID assigned to each service representative 220. Table 2, below, illustrates a report 213 in accordance with this embodiment.

TABLE 2

| | | | Actual | Expected | |
|---|---|---|---|---|---|
| | | | Chemical | Chemical | Chemical |
| | | | Usage over | Usage over | Usage Relative |
| Time Period | | | Time Period | Time Period | To Time |
| (hours) | User ID | Enterprise ID | (liters) | (liters) | Period (%) |
| 24:04:02 | 456-83-9968 | 18 | 140 | 90 | 64 |
| 30:30:45 | 439-96-9578 | 18 | 120 | 121 | 101 |
| 32:45:23 | 478-09-3820 | 18 | 125 | 129 | 103 |
| 40:46:19 | 440-96-9559 | 12 | 160 | 305 | 191 |
| 48:34:24 | 487-90-3280 | 15 | 190 | 200 | 105 |

The report 213 provides a mechanism through which chemical usage trends of service representatives 220, and therefore enterprises, e.g., 222 and 224, can be managed. For example, Table 2 shows that the service representative 220 having user ID #440-96-9559 is using almost double the amount of chemical product that has been estimated for that service representative 220. This type of analysis may give an indication to building management that this service representative 220 is receiving chemical products for an unauthorized use. In contrast, Table 2 shows that the service representative 220 having user ID #456-83-9968 is using only sixty-four percent of the amount of chemical product that has been estimated for that service representative 220. This type of analysis may give an indication to building management that this service representative 220 is not performing his or her assigned tasks. Other types of information, such as, without limitation total facility usage for certain chemicals, costs analyses, efficiency of the chemical dispense system 100, etc., may be generated by the analysis application and therefore included on a report 213 for evaluation by building management.

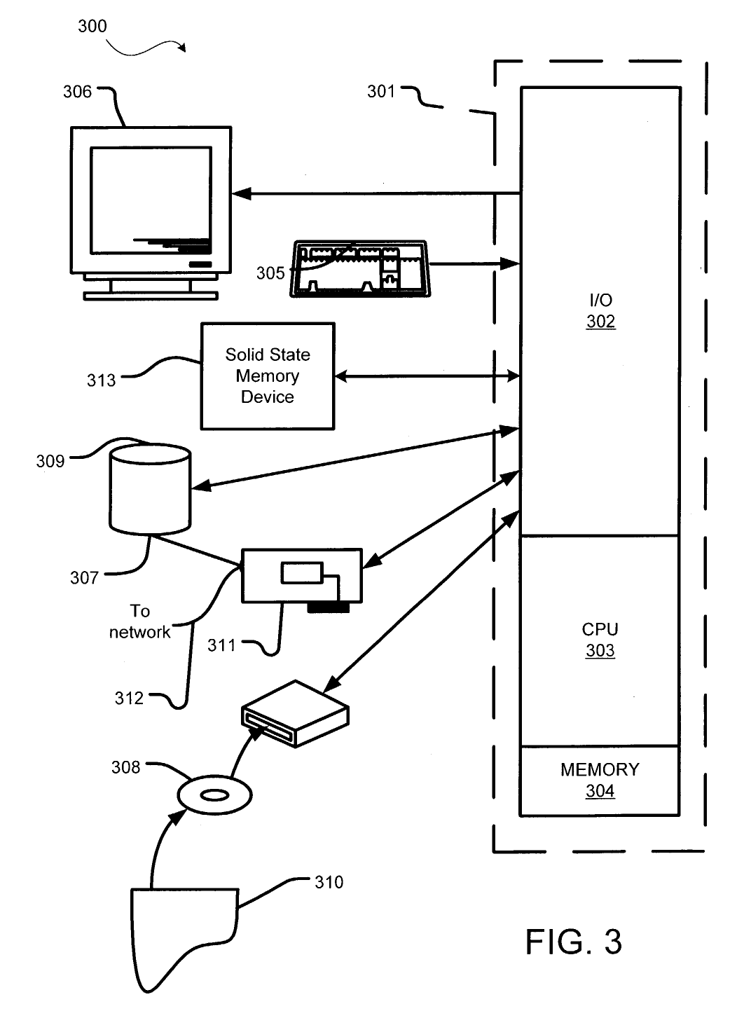

FIG. 3 depicts a computing system 300 capable of executing a program product embodiment of the present invention. One operating environment in which the present invention is potentially useful encompasses the computing system 300, such as, for example, the host computer 204, the server computer 210 and the client computer 214. In such a system, data and program files may be input to the computing system 300, which reads the files and executes the programs therein. Some of the elements of a computing system 300 are shown in FIG. 3 wherein a control module, illustrated as a processor 301, is shown having an input/output (I/O) section 302, a microprocessor, or Central Processing Unit (CPU) 303, and a memory section 304. The present invention is optionally implemented in software or firmware modules loaded in memory 304 and/or stored on a solid state, non-volatile memory device 313, a configured CD-ROM 308 or a disk storage unit 309. As such, the computing system 300 may be used as a “special-purpose” machine for implementing the present invention.

Each of the above-noted forms of data storage are broadly included within the definition of “computer program product” used throughout the specification and the claims. That is, generally stated, a computer program product of the present invention may be a solid state, non-volatile memory device or a computer storage media readable by a computer system and encoding a computer program of instructions for executing a computer process. In another embodiment, the computer program product may also be a propagated signal on a carrier readable by a computing system and encoding a computer program of instructions for executing a computer process.

The I/O section 302 is connected to a user input module 305, e.g., a keyboard, a display unit 306 and one or more program storage devices, such as, without limitation, the solid state, non-volatile memory device 313, the disk storage unit 309, and the disk drive unit 307. The user input module 305 is shown as a keyboard, but may also be any other type of apparatus for inputting commands into the processor 301. The solid state, non-volatile memory device 313 is an embedded memory device for storing instructions and commands in a form readable by the CPU 303. In accordance with various embodiments, the solid state, non-volatile memory device 313 may be Read-Only Memory (ROM), an Erasable Programmable ROM (EPROM), Electrically-Erasable Programmable ROM (EEPROM), a Flash Memory or a Programmable ROM, or any other form of solid state, non-volatile memory. In accordance with one embodiment, the disk drive unit 307 is a CD-ROM driver unit capable of reading the CD-ROM medium 308, which typically contains programs 310 and data. Computer program products containing mechanisms to effectuate the systems and methods in accordance with the present invention may reside in the memory section 304, the solid state, non-volatile memory device 313, the disk storage unit 309 or the CD-ROM medium 308.

In accordance with an alternative embodiment, the disk drive unit 307 may be replaced or supplemented by a floppy drive unit, a tape drive unit, or other storage medium drive unit. A network adapter 311 is capable of connecting the computing system 300 to a network of remote computers via a network link 312. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 300. Logical connections may include a local area network (LAN) or a wide area network (WAN). Such networking environments are commonplace in offices, enterprise-wide computer networks, intranets, and the Internet.

In accordance with a program product embodiment of the present invention, software instructions stored on the solid state, non-volatile memory device 313, the disk storage unit 309, or the CD-ROM 308 are executed by the CPU. In this embodiment, these instructions may be directed toward communicating data between a client and a server, detecting product usage data, analyzing data, and generating reports. Data, such as products usage data, corporate data, and supplemental data generated from product usage data or input from other sources, may be stored in memory section 304, or on the solid state, non-volatile memory device 313, the disk storage unit 309, the disk drive unit 307 or other storage medium units coupled to the system 300.

In accordance with one embodiment, the computing system 300 further comprises an operating system and usually one or more application programs. Such an embodiment is familiar to those of ordinary skill in the art. The operating system comprises a set of programs that control operations of the computing system 300 and allocation of resources. The set of programs, inclusive of certain utility programs, also provide a graphical user interface to the user. An application program is software that runs on top of the operating system software and uses computer resources made available through the operating system to perform application specific tasks desired by the user. In accordance with an embodiment, the operating system employs a graphical user interface wherein the display output of an application program is presented in a rectangular area on the screen of the display device 306. The operating system is operable to multitask, i.e., execute computing tasks in multiple threads, and thus may be any of the following: Microsoft Corporation's “WINDOWS 95,” “WINDOWS CE,” “WINDOWS 98,” “WINDOWS 2000” or “WINDOWS NT” operating systems, IBM's OS/2 WARP, Apple's MACINTOSH SYSTEM 8 operating system, X-windows, etc.

In accordance with the practices of persons skilled in the art of computer programming, the present invention is described below with reference to acts and symbolic representations of operations that are performed by the computing system 300, i.e., the host computer 204, the server computer 210 or the client computer 214, unless indicated otherwise. Such acts and operations are sometimes referred to as being computer-executed. It will be appreciated that the acts and symbolically represented operations include the manipulations by the CPU 303 of electrical signals representing data bits causing a transformation or reduction of the electrical signal representation, and the maintenance of data bits at memory locations in the memory 304, the solid state, non-volatile memory device 313, the configured CD-ROM 308 or the storage unit 309 to thereby reconfigure or otherwise alter the operation of the computing system 300, as well as other processing signals. The memory locations where data bits are maintained are physical locations that have particular electrical, magnetic, or optical properties corresponding to the data bits.

The logical operations of the various embodiments of the present invention are implemented either (1) as a sequence of computer-implemented steps running on a computing system, e.g., the host computer 204, the server computer 210 and the client computer 214, and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, acts, steps or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

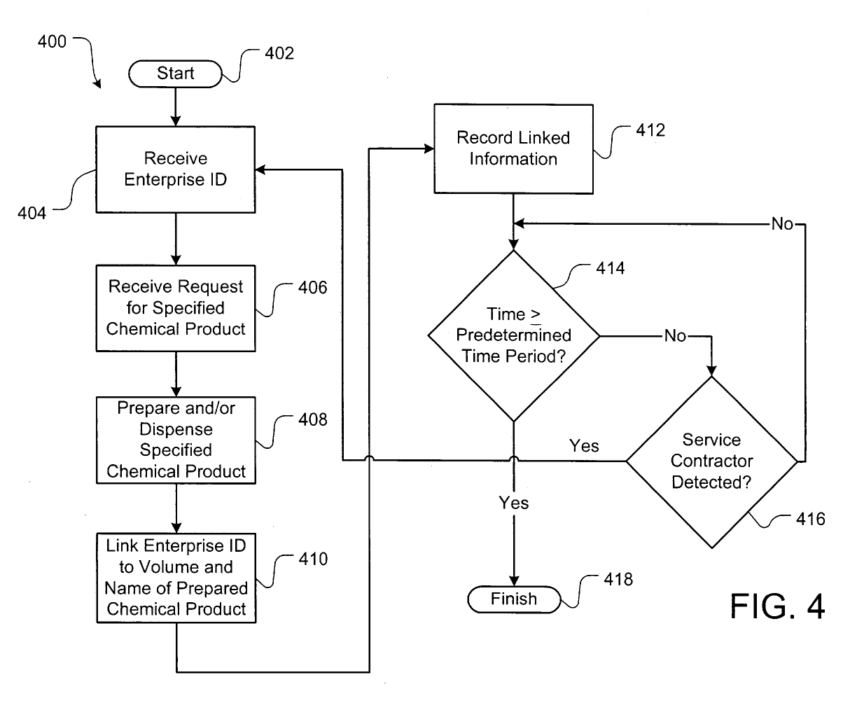

Referring now to FIG. 4, a process 400 generally illustrating operations for monitoring chemical usage by enterprises employed to manage cleaning tasks at a facility, building, complex or campus is shown in accordance with an embodiment of the present invention. The tasks include the application of a chemical product to an object, area or location of the facility, building, complex or campus. The chemical products are prepared and/or dispensed by one or more chemical dispense systems 100 as described above with respect to FIGS. 1 and 2. The monitoring process 400 therefore monitors dispensing of various chemical products by the chemical dispense system(s) 100.

In accordance with an embodiment, the monitoring process 400 shown in FIG. 4 monitors dispensing of chemical products by the chemical dispense system(s) 100 for one or more enterprises. In this embodiment, chemical usage information collected by the monitoring process 400 is used to compute actual volume of one or more chemical products dispensed for service representatives of a particular enterprise. Actual volume information may be used, for example, to generate a billing invoice for the enterprise. The billing invoice illustrates a cost owed by the enterprise for the chemical products dispensed to service representatives of that enterprise during a given period in time. Actual volume information may also be used to determine whether the enterprise is using the appropriate volumes of chemical products to perform a certain task.

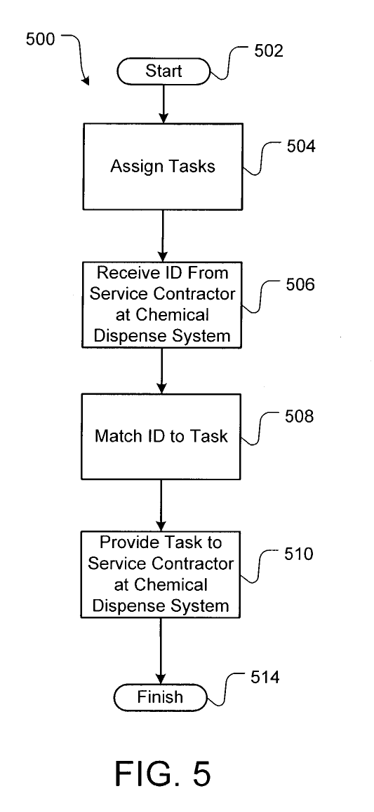

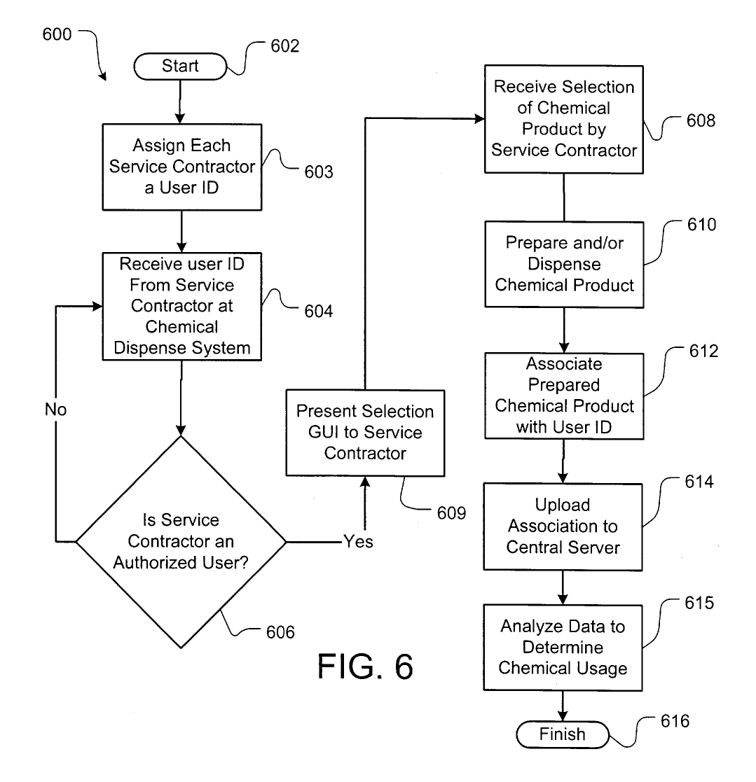

The enterprises are each associated with a unique enterprise identifier (ID). As such, each service representative is associated with the enterprise ID of the enterprise employing that service representative. As described in more detail in FIGS. 5 and 6, each service representative is associated with a unique user ID, and thus, information collected by the monitoring process 400 may be used in chemical usage analyses of an individual service representative rather than an enterprise as a whole.

The monitoring process 400 monitors chemical usage by one or more service representatives employed by one or more enterprises over a predetermined period of time. This predetermined period of time is set by the owner or manager of the facility, building, complex or campus where the chemical dispense system(s) 100 is (are) located. Although multiple chemical dispense systems 100 may be used to dispense chemical products for use in performance of various tasks at a single facility, building, complex or campus, the monitoring process 400 in FIG. 4 is described monitoring chemical product dispensing processes of a single chemical dispense system 100. The monitoring process is performed by an operation flow beginning with a start operation 402 and concluding with a terminate operation 418. Once initiated, the operation flow passes from the start operation 402 to a determine operation 404.

The determine operation 404 determines an enterprise ID associated with a service representative accessing the chemical dispense system 100 to request a specified chemical product. In accordance with an embodiment, the enterprise ID is directly input to the identification module 202 by the service representative. In accordance with another embodiment, the enterprise ID may be determined by the host computer 204 or central server 210 based on the user ID of the service representative input to the identification module 202. After the enterprise ID associated with the service representative is determined, the operation flow passes to a receive operation 406.

The receive operation 406 receives a request for a specified volume of a specified chemical product. The chemical product, as well as the volume thereof, may be specified by the service representative, or alternatively, pre-specified by the service representative's management entity or the owner/manager of the facility, building, complex or campus where the chemical dispense system 100 is located. From the receive operation 406, the operation flow passes to a dispense operation 408. The dispense operation 408 manages preparation and/or dispensing of the chemical product by the chemical dispense system 100 such that the specified volume is provided to the service representative. From the dispense operation 408, the operation flow passes to a link operation 410.

The link operation 410 associates the enterprise ID with the volume and name of the chemical product dispensed to the service representative. In an embodiment, the link operation 410 links the enterprise ID with the volume and name of the dispensed chemical product by time-stamping this information with a time reference. The time reference is relative to a point in time when the volume of the chemical product was dispensed by the chemical dispense system 100 to the service representative. The link operation 410 may be administered by either the host computer 204 or the central server 210. If administered by the central server 210, then the monitoring process 400 includes an upload operation (not shown) that is performed prior to the link operation 410. From the link operation 410, the operation flow passes to a record operation 412.

The record operation 412 stores the linked information to a database for storage such that the information may be used for subsequent chemical usage analyses. In an embodiment wherein the central server 210 performs the link operation 410, the record operation 412 stores the linked information in a database 212 accessible to the central server 210. In a first embodiment wherein the host computer 204 performs the link operation 412, the record operation 412 uploads the linked information to the central server 210 for storage in a database 212 accessible to the central server 210. The linked information is then stored in the database 212 in the form of a data structure associated with the chemical dispense system 100, the enterprise identified by the enterprise ID, the building, complex, facility or campus where the chemical dispense system 100 is located, or the service representative identified by the user ID. In a second embodiment wherein the host computer 204 performs the link operation 410, the record operation 412 stores the linked information in a database (not shown in FIG. 2) local to the chemical dispense system 100 and accessible to the host computer 204. The linked information is stored in the local database in the form of a data structure associated with the enterprise ID or the user ID. In this embodiment, the linked information is transmitted to the central server 210 along with other linked information collected by the monitoring process over the predetermined period of time. From the record operation 412, the operation flow passes to a query operation 414.

The query operation 414 determines whether the predetermined time period has lapsed. The query operation 414 therefore internally defines the time period in which the monitoring process 400 is executed to monitor chemical usage by one or more enterprises having service representatives that access the chemical dispense system 100. If the predetermined time period has lapsed, the operation flow concludes at the terminate operation 418. If the predetermined time period has not lapsed, the operation flow passes to a detect operation 416.

The detect operation 416 detects whether a service representative is subsequently accessing the chemical dispense system 100 to request a specified chemical product. The operation flow substantially continuously passes between the query operation 414 and the detect operation 416 until subsequent access by a service representative is detected. If, at any time, the predetermined time period expires, the operation flow concludes immediately at the terminate operation. Upon detection of a service representative subsequently accessing the chemical dispense system 100, the operation flow passes to the determine operation 404 and continues as previously described.

Referring now to FIG. 5, a process 500 generally illustrating operations for managing chemical usage by service representatives is shown in accordance with an embodiment of the present invention. Each service representative is assigned a unique user ID. The service representatives are employed to perform tasks at a building, facility or particular location. In an embodiment, the tasks include applying at least one chemical product to an area in the building, facility or location, or to an object at the building, facility or location. In accordance with various embodiments, the chemical product(s) may be used to clean, sanitize, fertilize, or eliminate pests from, the area or the object. The tasks are assigned to service representatives by a management entity of an enterprise which employs the service representatives. A management entity is generally defined as one or more individuals responsible for assigning tasks to service representatives. As such, these individuals may include a supervisor/manager of the enterprise employing the service representative or a tenant, owner or manager of the building, facility or location. It should be appreciated that the management entity may also be any company, group or organization responsible for delegating tasks to service representatives.

The management process 500 is performed by an operation flow beginning with a start operation 502 and concluding with a terminate operation 514. Once initiated, the operation flow passes from the start operation 502 to an assignment operation 504. The assignment operation 504 accepts tasks entered by a management entity. The tasks are to be performed by service representatives managed by the management entity. The management entity may be either management of an enterprise or an owner/manager of the facility, building, complex or campus to be serviced. Each task specifies a chemical product which is to be dispensed by a chemical dispense system 100 for application to a particular area, location or object by a service representative. As such, the tasks are assigned such that each task is associated with a specific service representative. If two service representatives are to perform the same task, then two separate identical tasks are assigned to each of these service representatives. Alternatively, tasks may be associated with multiple service representatives.

In accordance with an embodiment, the management entity enters the tasks into the client computer 214, which subsequently provides the tasks to the central server 210 over the communications link 211. Each task is then stored in the database 212 for subsequent access by the host computer 204 local to the chemical dispense system 100 that is to dispense a chemical product specified by each particular task. In accordance with an alternative embodiment, the management entity enters the tasks into the host computer 204 through the touch-screen GUI. In this embodiment, the tasks are uploaded from the host computer 204 to the central server 210. From the assignment operation 504, the operation flow passes to a receive operation 506.

The receive operation 506 receives a user ID input by a service representative at a chemical dispense system 100. The service representative enters the user ID using an identification module 202 located on the chemical dispense system 100. Once received, the user ID is passed from the identification module 202 to the central server 210 along with information identifying the chemical dispense system 100. The operation flow then passes to a match operation 508. The match operation 508 matches the user ID to one or more tasks associated with the user ID.

In accordance with an embodiment, the central server 210 performs the match operation 508. In this embodiment, data structures stored in the database 212 include records of tasks to be performed by the service representative. Each chemical dispense system 100 connected to the central server 210 is associated with a data structure stored in the database 212. Each task is matched to one or more user ID's in the data structure. Furthermore, each task is associated with a predetermined volume of one or more chemical product(s) that is to be dispensed by the chemical dispense system 100 corresponding to the data structure. The match operation 508 first pulls the appropriate data structure based on the chemical dispense system 100 that received the user ID.

Once the appropriate data structure has been retrieved, the match operation 508 references the data structure using the user ID to determine one or more tasks that the service representative is to perform. The match operation 508 also determines the predetermined volume of the one or more chemical product(s) needed to perform that task by referencing the data structure. Table 3, below, is an illustration of an exemplary data structure in which the above-noted information is saved in tabular form in the database 212 and accessible to both the central server 210 and the host computer 204, albeit by way of the central server 210.

TABLE 3

| User ID | Task | Chemical Product | Volume |
|---|---|---|---|
| 456-83-9968 | Clean Dining Room | Multipurpose/Floor | 30 |
| | | Cleaner | |
| 439-96-9578 | Polish Floor | Floor Polish | 40 |
| 478-09-3820 | Sanitize Washroom | Bowl & Bathroom | 25 |
| | | Cleaner | |
| 439-96-9578 | Clean Kitchen | Multipurpose/Floor | 15 |
| | | Cleaner | |
| 478-09-3820 | Spray for Insects | Insect Repellant | 10 |

After the task and chemical product are matched to the user ID, the operation flow passes to a present operation 510. In an embodiment, the present operation 510 transmits the task, the name of the associated chemical product and the predetermined volume of the chemical product to the host computer 210 of the chemical dispense system 100. The present operation 510 then presents both the task and the name of the associated chemical product to the service representative through the touch-screen GUI displayed on the display monitor 116. The volume predetermined for the chemical product may also be displayed on the touch-screen GUI. By presenting this information on the touch-screen GUI, the service representative can review the task as well as instruct the chemical dispense system 100 to dispense that chemical product. Alternatively, the present operation 510 may only transmit the task or the name of the chemical product to the host computer 210. In this embodiment, only the transmitted information, i.e., task or chemical product, is presented to the service representative through the touch-screen GUI.

In yet another embodiment, the present operation 510 may transmit both the retrieved task and the name of the associated chemical product, but only present the task on the touch-screen GUI. In this embodiment, the name of the chemical product is not presented on the touch-screen GUI for selection by the service representative, but rather the chemical dispense system 100 automatically dispenses the predetermined volume of that chemical product. In this manner, the service representative receives the proper volume of the chemical product needed to perform the task responsive to input of his/her user ID. After the chemical product is dispensed by the chemical dispense system 100, the operation flow concludes at the terminate operation 514.

Referring now to FIG. 6, a process 600 generally illustrating operations for monitoring chemical usage of service representatives is shown in accordance with an embodiment of the present invention. The monitoring process 600 monitors chemical usage by multiple service representatives using multiple chemical dispense systems 100 to dispense chemical products to be used in the performance of various tasks. The multiple service representatives may be associated with a single or multiple enterprises responsible for performance of cleaning tasks at one or more facilities, buildings, complexes or campuses. The multiple chemical dispense systems 100 are connected to the central server 210, as shown in FIG. 2.

The monitoring process 600 is performed by an operation flow beginning with a start operation 602 and concluding with a terminate operation 616. Once initiated, the operation flow passes from the start operation 602 to an assign operation 603. The assign operation 603 assigns each service representative a user ID. The user ID's are unique to the service representatives in that no two service representatives are assigned the same user ID. For example, without limitation, a user ID may be a personal identifier such as an employee number or a social security number. The assigned user ID's are recorded in a data structure stored in the database 112 such that the user ID's are readily accessible to the central server 210. This data structure also links each service representative's enterprise ID to his/her user ID. In accordance with an embodiment of the present invention, the data structure may also include identification of the chemical dispense systems 100 that each service representative is authorized to use. Table 4, below, is an illustration of an exemplary data structure in which the above-noted information is saved in tabular form.

TABLE 4

| | Enterprise | Service | Chemical Dispense |
|---|---|---|---|
| User ID | ID | representative | System(s) |
| 456-83-9968 | 18 | Michael Burns | CD 45, CD 49, CD 152 |
| 439-96-9578 | 18 | Tabatha Stallings | CD 49, CD 152 |
| 490-09-3820 | 18 | Qwen Doe | CD 9, CD 152 |
| 439-96-9578 | 12 | John Doe | CD 9 |
| 480-09-3820 | 15 | William Fredericks | CD 9, CD 185 |

After each authorized service representative is assigned a user ID, and the user ID is stored in the database 212, the operation flow passes to a first receive operation 604. The first receive operation 604 receives a user ID input by a service representative at a chemical dispense system 100. The service representative enters the user ID at an identification module 202 located on the chemical dispense system 100. Once the service representative's user ID is received, the operation flow passes to an authorization query operation 606. The authorization query operation 606 determines whether the service representative is an authorized user of the chemical dispense system 100. In accordance with an embodiment, the authorization query operation 606 checks the received user ID against the data structure stored in the database 112 that contains all user ID's of the service representatives that are authorized to use chemical dispense systems 100 connected to the central server 210.

If the authorization query operation 606 determines that the service representative is an authorized user, the operation flow passes to a display operation 607. The display operation 607 presents a selection page on the touch-screen GUI. The selection page includes graphics, i.e., icons, text, buttons, etc., for selecting a chemical product for the chemical dispense system 100 to dispense. In accordance with an embodiment shown in FIG. 4, the selection page may include only those chemical products that the service representative is authorized to use. Alternatively, the selection page may be a default selection page allowing the service representative to select any chemical product that the chemical dispense system 100 may dispense given the concentrates, or alternatively pre-formed chemical products, stored in the system 100. If the authorization query operation 606 determines that the service representative is not an authorized user, the operation flow passes to back to the receive operation 604 and continues as previously described.

From the display operation 607, the operation flow passes to a second receive operation 608. The second receive operation 608 receives a selection of a particular chemical product by the service representative. In an embodiment, the service representative selects the chemical product by selecting a graphic on the selection page or typing in the name of the chemical product to the touch-screen GUI. After this selection is received, the operation flow passes to a dispense operation 610. The dispense operation 610 prepares and/or dispenses the chemical product selected by the service representative. After the chemical product is dispensed, the operation flow passes to an association operation 612.

The association operation 612 links the user ID of the service representative to the volume and name of the chemical product dispensed by the chemical dispense system 100 in response to the service representative's selection. The associate operation 612 also links the user ID of the service representative to the enterprise ID associated with the service representative. This linked information is recorded in a data structure, e.g., data file, in accordance with an embodiment of the present invention. In this embodiment, the association operation 612 also time stamps the linked information with a time reference relative to a point in time that the chemical product was dispensed by the chemical dispense system 100. This time reference, which includes both the calendar date and clock information, is recorded into the data structure such that the data structure contains at least the user ID for the service representative, the enterprise ID associated with the service representative, the volume and the name of the chemical product dispensed to that service representative and the associated time reference.

In one possible embodiment, the chemical dispense system 100 includes a host computer 204 for creating and updating the data structure. In this embodiment, the data structure is stored in a local storage device until such time that the data structure is uploaded by the communication module 206 to the central server 210. In another embodiment, the central server 210 creates and updates this data structure, and as such, is in continuous communication with the chemical dispense system 100 by way of the communication module 206. The received user ID, the volume and the name of the dispensed chemical product are therefore transmitted directly from the chemical dispense system 100 to the central server 210 in this embodiment. The data structure is stored in the database 212, where the data structure is readily accessible by the central server 210.

An exemplary data structure according to this embodiment is shown above in Table 1, wherein the data structure is continuously updated to include this information for each instance that a service representative receives a chemical product dispensed by the chemical dispense system 100. In accordance with an alternative embodiment, each instance that a service representative receives a chemical product is recorded in a separate data structure. In this embodiment, the data structure only contains the time reference, the enterprise and user ID of the service representative, the volume and the name of the dispensed chemical product for this particular selection by the service representative.

After the time reference, the enterprise and user ID of the service representative, and the name of the dispensed chemical product are recorded to the data structure, the operation flow passes to an upload operation 614 in accordance with the embodiment wherein a host computer 204 local to the chemical dispense system 100 creates and updates the data structure. In this embodiment, the upload operation 614 retrieves the data structure from the local storage device and transmits the data structure to the central server 210. Once received by the central server 210, the data structure is saved to the database 212. From the upload operation 614, the operation flow passes to an analysis operation 615. In the embodiment wherein a host computer 204 is not used to create the data structure, the operation flow bypasses the upload operation 614 and passes straight to the analysis operation 615.

The analysis operation 615 analyzes the data, e.g., enterprise and user ID's, volumes and names of dispensed chemical products and time references, stored in the database to render conclusions related to the chemical usage by either 1) each enterprise responsible for at least one service representative assigned a user ID by the assign operation 603, or 2) each service representative assigned a user ID by the assignment operation 603. In an embodiment, the analysis operation 615 adds volume of a chemical product dispensed for either 1) an enterprise, or 2) a service representative during a given period of time. This computation renders an actual volume that the analysis operation 615 can compare to a predetermined volume estimated for use by either 1) the enterprise, or 2) the service representative. Indeed, the analysis operation 615 may repeat this computation for each chemical product dispensed for either 1) the enterprise, or 2) the service representative.

In accordance with another embodiment, the analysis operation 615 computes the total volume of one or more particular chemical product(s) dispensed by a specific chemical dispense system 100, or alternatively, by all the chemical dispense systems 100 connected to the central server 210, over a given period of time. This computation renders an actual volume that the analysis operation 615 can compare to a predetermined volume estimated for the chemical dispense system 100, or alternatively, all chemical dispense systems 100. The analysis operation 615 may use the above-noted computations of these embodiments to determine various other operational and functional characteristics of the chemical dispense systems 100 connected to the central server 210. For example, without limitation, each of the above-noted computations may be used by the analysis operation 615 to determine efficiency of one or more of the chemical dispense systems 100 connected to the central server 210 or to generate a billing invoice for one or more of the chemical dispense systems 100 connected to the central server 210.

The central server 210 is connected to a client computer 214 in one possible embodiment, as shown in FIG. 2. In this embodiment, the client computer 214 may perform the analysis operation 615. The client computer 214 may generate reports 213 depicting the conclusions made by the analysis operation 615. From the analysis operation 615, the operation flow concludes at a terminate operation 616.

It will be clear that the present invention is well adapted to attain the ends and advantages mentioned, as well as those inherent therein. While a presently preferred embodiment has been described for purposes of this disclosure, various changes and modifications may be made which are well within the scope of the present invention. For example, in accordance with one possible embodiment, the user ID may be associated with a utility device that requests a specific chemical product from a chemical dispense system 100. Such an embodiment is particularly useful in context of a utility device coupled to a chemical dispense system 100 that dispenses a chemical product for use by the utility device to perform a cleaning task. A warewashing machine coupled to a chemical dispense system 100 that dispenses detergent thereto would be an example of such a utility device. In this embodiment, the utility device would be considered a user, and therefore associated with a particular enterprise by way of an enterprise ID linked to a user ID assigned to that utility device.

Additionally, in an alternative embodiment, the present invention may be used to monitor product usage by an enterprise or service representative wherein the product is a form of product other than a chemical product. In this embodiment, the product is dispensed using a product dispense system rather than a “chemical” product dispense system, as shown in FIG. 1. For example, the product dispense system may be a type of vending machine that dispenses a product used by service representatives to perform a task for or on behalf of a particular enterprise, wherein the product dispense system is used by one or more service representatives employed by a plurality of enterprises.

In yet another embodiment, the identification module 202 may be a Radio Frequency IDentification (RFID) tag reader. In this embodiment, the user ID of a service representative is embedded in an RFID tag that service representatives swipe in front of the identification module 202. An RFID tag includes a silicon chip programmed with the user ID for the service representative. The RFID tag reader creates a magnetic field in or around the formulator 102. The magnetic field generates a current in the coil of the RFID tag as the tag is swiped in front of the formulator 102. The current powers the silicon chip to provide the user ID assigned to that service representative to the tag reader, which thereafter provides the user ID to the host computer 214 of the chemical dispense system 100.

The present invention may also be used in circumstances where a managing enterprise is responsible for managing the duties of both internal and external service representatives. In this circumstance, it is not unusual for the contract between a managing enterprise and its external service representatives to include the cost of the cleaning agents used by each representative. The internal representatives that perform cleaning activities on behalf of the managing enterprise also require cleaning agents; however, the internal representatives are not typically responsible for the cost of cleaning agents used. To maintain a high and consistent cleaning standard, the managing enterprise may remove the cost of the cleaning agents from the contracts with its external representatives. As such, regardless of whether a cleaning agent is requested by an internal or an external service representative, management of dispense operations using the present invention is performed in substantially the same manner. The correct volume and type of the requested cleaning agent are therefore dispensed to and recorded for each authorized user to assure there is a consistent result for both internal and external representatives.

Furthermore, formulation processes of the chemical dispense system 100 are used herein to illustrate the management processes of the present invention in accordance with an exemplary embodiment. It should be appreciated, however, that processes associated with the allocator 104 of the chemical dispense system 100 may be similarly managed, i.e., monitored and controlled, by the present invention to provide pre-formed chemical products to authorized representatives in accordance with yet other embodiments. In either of these embodiments, it should also be appreciated that the identification module 202, host computer 204 and communication device 206 of a chemical dispense system 100 may be remotely located from the fill station 114 of the chemical dispense system 100. As such, the fill station 114 may include a communications module for receiving commands from the host computer 204 over a communications network. Numerous other changes may be made which will readily suggest themselves to those skilled in the art and which are encompassed in the spirit of the invention disclosed and as defined in the appended claims.

What is claimed is:

1. A method for monitoring usage of one or more chemical products dispensed by a chemical dispense system, wherein a plurality of enterprises are responsible for managing cleaning tasks performed using the one or more chemical products, the cleaning tasks being performed by service representatives employed by the plurality of enterprises, the method comprising:
associating an enterprise identifier (ID) to each of the plurality of enterprises such that each service representative employed by a single enterprise is associated with the same enterprise ID;
receiving a first request for the chemical dispense system to dispense a chemical product, wherein the first request comprises a first enterprise ID associated with a first enterprise employed to perform a first cleaning task;
receiving a second request for the chemical dispense system to dispense a chemical product, wherein the second request comprises a second enterprise ID associated with a second enterprise employed to perform a second cleaning task, and
linking the first enterprise ID to a name of the chemical product requested by the first request and a dispensed volume of the chemical product requested by the first request; and
linking the second enterprise ID to a name of the chemical product requested by the second request and a dispensed volume of the chemical product requested by the second request.

2. A method as defined in claim 1, further comprising:
associating the first enterprise ID, the name of the chemical product linked to the first enterprise ID and the dispensed volume of the chemical product linked to the first enterprise ID with a time reference relative to a point in time wherein the chemical dispense system dispensed the chemical product; and
associating the second enterprise ID, the name of the chemical product linked to the second enterprise ID and the dispensed volume of the chemical product linked to the second enterprise ID with a time reference relative to a point in time wherein the chemical dispense system dispensed the chemical product.

3. A method as defined in claim 2 further comprising:
uploading the first and second enterprise ID's, the names of the chemical products linked to the first and second user ID's, the dispensed volumes of the chemical products linked to the first and second user ID's, and the time references to a central server over a network connection.

4. A method as defined in claim 3, further comprising:
recording the first and second enterprise ID's, the names of the chemical products linked to the first and second enterprise ID's, the dispensed volumes of the chemical products linked to the first and second enterprise ID's, and the time references to a data structure associated with the chemical dispense system; and
storing the data structure in a database accessible to the central server.

5. A method as defined in claim 4, further comprising:
repeating the receiving acts, the associating acts, and the uploading act for each subsequent request during a predetermined period of time; and
updating the data structure to include the first and second enterprise ID's, the names the chemical products linked to the first and second enterprise ID's, the dispensed volumes of the chemical products linked to the first and second enterprise ID's, and the time references uploaded by the uploading act during the predetermined period of time.

6. A method as defined in claim 5, further comprising:
analyzing information recorded in the data structure to generate a billing invoice based on the volumes of chemical products dispensed for the first enterprise.

7. A method as defined in claim 6, further comprising:
analyzing information recorded in the data structure to evaluate usage trends of the chemical products dispensed for the first enterprise during the predetermined period of time.

8. A method as defined in claim 7, wherein the analyzing act comprises:
compiling an actual volume of each of the chemical products dispensed for the first enterprise during the predetermined period of time; and
wherein the method further comprises:
presenting the actual volume of the chemical products dispensed for the first enterprise during the predetermined period of time to a management entity for evaluation of usage trends of the chemical products by the first enterprise.

9. A method as defined in claim 8, wherein the analyzing act further comprises:
comparing the actual volume of each chemical product dispensed for the first enterprise to an expected volume to render a conclusion related to usage trends of the chemical products by the first enterprise during the predetermined period of time; and
wherein the method further comprises:
presenting the conclusion to a management entity for evaluation of usage trends of the chemical products by the first enterprise.

10. A method as defined in claim 1, further comprising:
associating each service representative authorized to access the chemical dispense system with a unique user identifier (ID).

11. A method as defined in claim 10, wherein the receiving a first request act comprises:
receiving a first user ID associated with a first service representative employed by the first enterprise to perform a cleaning task.

12. A method as defined in claim 11, further comprising:
comparing the first user ID to the unique user ID's assigned to each service representative authorized to access the chemical dispense system to determine whether the first service representative is an authorized user of the chemical dispense system.

13. A method as defined in claim 12, further comprising:
presenting a selection page on a graphical user interface of the chemical dispense system if the first service representative is determined to be an authorized user of the chemical dispense system, wherein the selection page enables the first service representative to request the chemical dispense system to dispense the chemical product.

14. A method as defined in claim 13, further comprising:
linking one or more predetermined chemical products to the first user ID such that the first service representative is authorized to request that the chemical dispense system dispense the one or more predetermined chemical products, wherein the chemical product dispensed in response to the request by the first service representative is one of the one or more predetermined chemical products to which the first user ID is linked.

15. A method as defined in claim 14, wherein the presenting act comprises:
displaying the one or more predetermined chemical products on the selection page such that the first service representative is limited to selection of the one or more predetermined chemical products.

16. A method as defined in claim 15, wherein act of linking the first enterprise ID comprises linking each of the one or more predetermined chemical products to a specified volume that the first service representative is authorized to use.

17. A method as defined in claim 16, wherein the specified volumes of each of the one or more predetermined chemical products are set by a management entity responsible for managing usage trends of chemical products by the first service representative.

18. A system for monitoring usage of one or more chemical products dispensed by a chemical dispense system, wherein a plurality of enterprises are responsible for managing cleaning tasks performed using the one or more chemical products, the cleaning tasks being performed by service representatives employed by the enterprises, each service representative being associated with an enterprise identifier (ID) corresponding to the enterprise through which the service representative is employed, the system comprising:
an identification module receiving a request from a service representative for the chemical dispense system to dispense a specified chemical product, wherein the request comprises an enterprise ID associated with the service representative;
a host computer operably coupled to the identification module to receive the request and controlling the chemical dispense system to dispense the specified chemical product;
a communication module operably connected to the host computer for transmitting information between the host computer and a network connection; and
a central server receiving the enterprise ID, a name of the specified chemical product and a dispensed volume of the specified chemical product from the communication module over the network connection and associating the name of the specified chemical product and the dispensed volume of the specified chemical product to an appropriate enterprise based on the enterprise ID.

19. A system as defined in claim 18, wherein:
the identification module receives one or more enterprise ID's in a plurality of requests by one or more service representatives for the chemical dispense system to dispense one or more specified chemical products, wherein the plurality of requests are received over a predetermined period of time;
the host computer controls the chemical dispense system to dispense the specified chemical products in response to the plurality of requests; and
the central server associates the names of the one or more specified chemical products and the dispensed volumes of the one or more specified chemical products to an appropriate enterprise based on the enterprise ID's included within the plurality of requests.

20. A system as defined in claim 19, wherein the central server associates the enterprise ID's, the names of the one or more specified chemical products and the dispensed volumes of the one or more specified chemical products with a time reference relative to a time when each of the plurality of requests was received by the identification module.

21. A system as defined in claim 20, wherein the central server records the enterprise ID's, the names of the one or more specified chemical products, the dispensed volumes of the one or more specified chemical products, and the linked time references to a data structure associated with the chemical dispense system, the system further comprising:
a database accessible to the central server and storing the data structure.

22. A system as defined in claim 21, further comprising:
a client computer connected to the central server over a communications link, receiving the data structure from the central server over the communications link and analyzing information recorded in the data structure to evaluate usage trends of chemical products dispensed to the one or more service representatives by the first service representative.

23. A system as defined in claim 22, wherein the communications link is the network connection operably connecting the communication module to the central server.

24. A system as defined in claim 21, wherein the central server analyzes information recorded in the data structure to evaluate usage trends of chemical products dispensed by the chemical dispense system.

25. A system as defined in claim 24, wherein the central server compiles an actual volume of one or more chemical products dispensed for a specific enterprise over the predetermined period of time, the system further comprising:
a client computer connected to the central server over a communications link, receiving the compiled actual volume of the one or more chemical products dispensed for the specific enterprise over the predetermined period of time from the central server over the communications link and presenting the actual volume of the one or more chemical products dispensed for the specific enterprise over the predetermined period of time to a management entity for evaluation of usage trends of chemical products dispensed to service representatives of the specific enterprise.

26. A system as defined in claim 17, wherein each service representative authorized to access the chemical dispense system is associated with a unique user identifier (ID) and the request received by the identification module comprises a unique user ID associated with a first service representative attempting to access the chemical dispense system.

27. A system as defined in claim 26, wherein the identification module compares the unique user ID associated with the first service representative to the unique user ID's associated with each service representative authorized to use the chemical dispense system to determine whether the first service representative is an authorized user of the chemical dispense system.

28. A system as defined in claim 27, wherein the host computer comprises:
a display monitor displaying a graphical user interface (GUI), the GUI presenting a selection page enabling the first service representative to request that the chemical dispense system dispense the chemical product if the first service representative is determined to be an authorized user of the chemical dispense system.

29. A system as defined in claim 28, wherein the central server links one or more predetermined chemical products to the user ID associated with the first service representative such that the first service representative is authorized to request that the chemical dispense system dispense the one or more predetermined chemical products, the chemical product dispensed in response to the request by the first service representative being one of the one or more predetermined chemical products to which the user ID associated with the first service representative is linked.

30. A system as defined in claim 29, wherein the GUI presents the one or more predetermined chemical products on the selection page such that the first service representative is limited to selection of the one or more predetermined chemical products.

31. A system as defined in claim 30, wherein the central server links each of the one or more predetermined chemical products to a specified volume that the first service representative is authorized to use.

32. A computer program product readable by a computing system and encoding a computer program for executing a computer process for monitoring usage of one or more chemical products dispensed by a chemical dispense system, wherein a plurality of enterprises are responsible for managing cleaning tasks performed using the one or more chemical products, the cleaning tasks being performed by service representatives employed by the plurality of enterprises, the computer process comprising:
associating an enterprise identifier (ID) to each of the plurality of enterprises such that each service representative employed by a single enterprise is associated with the same enterprise ID;
receiving a first request for the chemical dispense system to dispense a chemical product, wherein the first request comprises a first enterprise ID associated with a first enterprise employed to perform a first cleaning task;
receiving a second request for the chemical dispense system to dispense a chemical product, wherein the second request comprises a second enterprise ID associated with a second enterprise employed to perform a second cleaning task, and
linking the first enterprise ID to a name of the chemical product requested by the first request and a dispensed volume of the chemical product requested by the first request; and
linking the second enterprise ID to a name of the chemical product requested by the second request and a dispensed volume of the chemical product requested by the second request.

33. A computer program product as defined in claim 32, wherein the computer process further comprises:
associating the first enterprise ID, the name of the chemical product linked to the first enterprise ID and the dispensed volume of the chemical product linked to the first enterprise ID with a time reference relative to a point in time wherein the chemical dispense system dispensed the chemical product; and
associating the second enterprise ID, the name of the chemical product linked to the second enterprise ID and the dispensed volume of the chemical product linked to the second enterprise ID with a time reference relative to a point in time wherein the chemical dispense system dispensed the chemical product.

34. A computer program product as defined in claim 33, wherein the computer process further comprises:
uploading the first and second enterprise ID's, the names of the chemical products linked to the first and second user ID's, the dispensed volumes of the chemical products linked to the first and second user ID's, and the time references to a central server over a network connection.

35. A computer program product as defined in claim 34, wherein the computer process further comprises:
recording the first and second enterprise ID's, the names of the chemical products linked to the first and second enterprise ID's, the dispensed volumes of the chemical products linked to the first and second enterprise ID's, and the time references to a data structure associated with the chemical dispense system; and
storing the data structure in a database accessible to the central server.

36. A computer program product as defined in claim 35, wherein the computer process further comprises:
repeating the receiving acts, the associating acts, and the uploading act for each subsequent request during a predetermined period of time; and
updating the data structure to include the first and second enterprise ID's, the names the chemical products linked to the first and second enterprise ID's, the dispensed volumes of the chemical products linked to the first and second enterprise ID's, and the time references uploaded by the uploading act during the predetermined period of time.

37. A computer program product as defined in claim 36, wherein the computer process further comprises:
analyzing information recorded in the data structure to generate a billing invoice based on the volumes of chemical products dispensed for the first enterprise.

38. A computer program product as defined in claim 37, wherein the computer process further comprises:
analyzing information recorded in the data structure to evaluate usage trends of the chemical products dispensed for the first enterprise during the predetermined period of time.

39. A computer program product as defined in claim 38, wherein the analyzing act comprises:
compiling an actual volume of each of the chemical products dispensed for the first enterprise during the predetermined period of time; and
wherein the method further comprises:
presenting the actual volume of the chemical products dispensed for the first enterprise during the predetermined period of time to a management entity for evaluation of usage trends of the chemical products by the first enterprise.

40. A computer program product as defined in claim 39, wherein the analyzing act further comprises:
comparing the actual volume of each chemical product dispensed for the first enterprise to an expected volume to render a conclusion related to usage trends of the chemical products by the first enterprise during the predetermined period of time; and
wherein the method further comprises:
presenting the conclusion to a management entity for evaluation of usage trends of the chemical products by the first enterprise.

41. A computer program product as defined in claim 32, wherein the computer process further comprises:
associating each service representative authorized to access the chemical dispense system with a unique user identifier (ID).

42. A computer program product as defined in claim 41, wherein the receiving a first request act comprises:
receiving a first user ID associated with a first service representative employed by the first enterprise to perform a cleaning task.

43. A computer program product as defined in claim 42, wherein the computer process further comprises:
comparing the first user ID to the unique user ID's assigned to each service representative authorized to access the chemical dispense system to determine whether the first service representative is an authorized user of the chemical dispense system.

44. A computer program product as defined in claim 43, wherein the computer process further comprises:
presenting a selection page on a graphical user interface of the chemical dispense system if the first service representative is determined to be an authorized user of the chemical dispense system, wherein the selection page enables the first service representative to request the chemical dispense system to dispense the chemical product.

45. A computer program product as defined in claim 44, wherein the computer process further comprises:
linking one or more predetermined chemical products to the first user ID such that the first service representative is authorized to request that the chemical dispense system dispense the one or more predetermined chemical products, wherein the chemical product dispensed in response to the request by the first service representative is one of the one or more predetermined chemical products to which the first user ID is linked.

46. A computer program product as defined in claim 45, wherein the presenting act comprises:
displaying the one or more predetermined chemical products on the selection page such that the first service representative is limited to selection of the one or more predetermined chemical products.

47. A computer program product as defined in claim 46, wherein act of linking the first enterprise ID comprises linking each of the one or more predetermined chemical products to a specified volume that the first service representative is authorized to use.

48. A computer program product as defined in claim 47, wherein the specified volumes of each of the one or more predetermined chemical products are set by a management entity responsible for managing usage trends of chemical products by the first service representative.

49. A system for monitoring usage of one or more products dispensed by a product dispense system, wherein a plurality of enterprises are responsible for managing tasks performed by service representatives using the one or more products, wherein each service representative authorized to access the product dispense system is associated with an enterprise identifier (ID), the system comprising:
an identification module receiving a request from a service representative for the product dispense system to dispense a specified product, wherein the request comprises an enterprise ID associated with the service representative; and
a host computer receiving the request from the identification module and associating a name of the specified product and a requested volume of the specified chemical product to an appropriate enterprise based on the enterprise ID.

50. A system as defined in claim 49, wherein the product is a chemical product.

51. A system as defined in claim 49, wherein the host computer comprises:
a communication module for transmitting the enterprise ID, the name of the specified chemical product and the requested volume of the specified chemical product to a remote central server over a network connection.

52. A system as defined in claim 51, wherein the enterprise ID, the name of the specified chemical product and the requested volume of the specified chemical product to a database accessible to the central server.

53. A system as defined in claim 52, wherein the identification module receives, over a predetermined period of time, one or more enterprise ID's in a plurality of requests by one or more service representatives for the chemical dispense system to dispense one or more specified chemical products and the host computer associates the names of the one or more specified chemical products and requested volumes of the one or more specified chemical products to an appropriate enterprise based on the enterprise ID's included within the plurality of requests.

54. A system as defined in claim 53, wherein the one or more enterprise ID's received by the identification module over the predetermined period of time and the names and requested volumes of the one or more specified chemical products is transmitted to the central server for storage in the database.

55. A system as defined in claim 54, wherein the central server analyzes information recorded in the database to evaluate usage trends of chemical products dispensed by the chemical dispense over the predetermined period of time.

56. A system as defined in claim 49, wherein each service representative authorized to access the chemical dispense system is associated with a unique user identifier (ID) and the request received by the identification module comprises a unique user ID associated with a first service representative attempting to access the chemical dispense system.

57. A system as defined in claim 56, wherein the host computer compares the unique user ID associated with the first service representative to unique user ID's associated with each service representative authorized to use the chemical dispense system to determine whether the first service representative is an authorized user of the chemical dispense system.

58. A system as defined in claim 57, wherein the host computer comprises:
a display monitor displaying a graphical user interface (GUI), the GUI presenting a selection page enabling the first service representative to request that the chemical dispense system dispense the chemical product if the first service representative is determined to be an authorized user of the chemical dispense system.

59. A system as defined in claim 58, wherein the user ID associated with the first service representative is linked to one or more predetermined chemical products such that the first service representative is authorized to request that the chemical dispense system dispense the chemical product, the specified chemical product being one of the predetermined chemical products.

60. A system as defined in claim 59, wherein the GUI presents the one or more predetermined chemical products on the selection page such that the first service representative is limited to selection of the one or more predetermined chemical products.

61. A system as defined in claim 60, wherein the host computer controls dispensing of the specified chemical product responsive to selection of the specified chemical product by the first service representative.
